(19) United States
(12) Patent Application Publication
(10) Pub. No.: US 2025/0338033 A1
(43) Pub. Date: Oct. 30, 2025

(54) PROCESSING-IN-PIXEL-IN-MEMORY FOR NEUROMORPHIC IMAGE SENSORS

(71) Applicant: UNIVERSITY OF SOUTHERN CALIFORNIA, Los Angeles, CA (US)

(72) Inventors: Ajey Poovannummoottil JACOB, Watervliet, NY (US); Akhilesh JAISWAL, Madison, WI (US); Md ABDULLAH-AL KAISER, Los Angeles, CA (US)

(21) Appl. No.: 19/257,303

(22) Filed: Jul. 1, 2025

Related U.S. Application Data
(63) Continuation of application No. PCT/US2024/010343, filed on Jan. 4, 2024.
(60) Provisional application No. 63/478,468, filed on Jan. 4, 2023.

(51) Int. Cl. H04N 25/47; H04N 25/779

(52) U.S. Cl. CPC H04N 25/47; H04N 25/779

(57) ABSTRACT

Provided is an integrated circuit comprising: a sensor structure; a set of weighting elements, each configured to weight an output of the sensor structure; and an output accumulation element, the output accumulation element configured to collect weighted outputs of the set of weighting elements over an accumulation time.

### GOVERNMENT LICENSE RIGHTS

This invention was made with government support under grant number HR00112190120 awarded by the Defense Advanced Research Projects Agency (DARPA). The government has certain rights in the invention.

### CROSS-REFERENCE TO RELATED APPLICATIONS

This application claims the benefit of U.S. Provisional Pat. App. 63/478,468, titled PROCESSING-IN-PIXEL-IN-MEMORY FOR NEUROMORPHIC IMAGE SENSORS, filed 4 Jan. 2023, the entire content of each of which is hereby incorporated by reference.

### BACKGROUND

Computer vision tasks-which may operate by using a camera (including a neuromorphic camera)—may suffer from the bottlenecks in energy, latency, and throughput, especially when involving compute intensive determinations (e.g., inferences, identifications, etc.), which may be remote from image sensors. Energy-efficient computing solutions are in high demand to process a vast amount of sensory data for on-edge intelligent machine vision applications. Hence, researchers have been exploring different approaches such as near-sensor processing, in-sensor processing, and in-pixel processing, and other methods of bringing the computation closer to a sensor. Among the various solutions, in-pixel processing may embed the computation capabilities inside the pixel array and may therefore exhibit higher energy efficiency by generating low-level features, which may be communicated to further processing layers, such as instead of the raw data stream from CMOS Image Sensors. Many different in-pixel processing techniques and approaches have been demonstrated on conventional frame-based CMOS imagers, however, the processing-in-pixel approach for asynchronous Neuromorphic Vision Sensors has had less attention.

While the present techniques are susceptible to various modifications and alternative forms, specific embodiments thereof are shown by way of example in the drawings included or described herein. The drawings may not be to-scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### SUMMARY

The following is a non-exhaustive list of some aspects of the present techniques. These and other aspects are described in the following disclosure.

Some aspects include a neuromorphic camera, one or more pixel, or other sensor. Some aspects include a neuromorphic camera or other camera based on dynamic vision sensors (DVS). Some aspects include other event sensors—including spike sensors, positive event sensors, negative event sensors (e.g., absence of an event), etc.

Some aspects include an array of pixels, such as an array of DVS, CIS, or other sensors. Pixels may include one or more photodetectors, photodiode, etc. Some aspects include an array of sensors which may be other than image pixels, for example, pressure pixels, temperature pixels, etc. or in addition to image pixels.

Some aspects include an array, such as of pixels, connected with multiple multi-bit multi-channel weight transistors or other weighting elements, such as which may correspond to one or more kernel. Some aspects include weighting elements which may weigh an output of elements of an array, including weighting elements of the array differently. Some aspects include constant or otherwise hardcoded weighting values. Some aspects include programmable or otherwise adjustable weighting values. Some aspects include weighting elements corresponding to each kernel connected to each element (e.g., pixel) of the array. Some aspects include multiple weighting elements per kernel per pixel. The weighting elements may be transistors, diodes, resistors, etc.

Some aspects include an array, such as of pixels, connected with integrating capacitors or other integrating (as of charge, current, etc.) elements. Some aspects include a passive memory (e.g., a charge accumulation memory). Some aspects include an active memory (e.g., one or more write memory, register, etc.).

Some aspects include an array, such as of pixels, connected with memory, which may be active analog memory, non-volatile emerging memory, or other memory element. The memory may function as an integration element or other memory which stores values of output of the array, including weighted values, which occur over a time, which may be an accumulation time.

Some aspects include high threshold voltage weighting transistors or other leakage reduction elements. Some aspects include elements which operate in one or more low leakage regimes. Some aspects include one or more isolation elements, such as which reduces leakage.

Some aspects include one or more switches to disconnect weighting elements from integrating elements or memory elements. Some aspects include a switch which cycles. Some aspects include a switch which may be triggered by a value, including a charge value, a time value, a clock value, etc.

Some aspects include a nullifying or reset current or voltage source to reduce leakage of an integrating element, such as an integrating capacitor. Some aspects include an active reset, such as a rewrite, overwrite, etc. of the integrating element. Some aspects include a passive reset, such as a draw down due to leakage current.

Some aspects include a thresholding circuit attached to the integrating element or memory element. Some aspects include a summation element. Some aspects include a difference element.

Some aspects include an in-pixel analog convolution operation.

Some aspects include an in-pixel thresholding operation.

Some aspects include one or more in-pixel operations depending on asynchronous detection events, such as asynchronous DVS input spikes.

Some aspects include a method of reading detection events, such as asynchronous detection events, DVS input spikes, etc., based on an address-event representation (AER) scheme. Some aspects include a global addressing element, such as bit line, row line, etc.

Some aspects include homogeneous integration, including of the weighting elements and array (e.g., of pixels). Some aspects include heterogeneous integration, including using through silicon vias (TSVs) or other electrical connections between an integrated circuit having the array of sensors and an integrated circuit having weighting elements, integration elements, etc.

Some aspects provide an improvement in computational speed, energy efficiency, lower bandwidth requirement, etc. over previous technology. Some aspects include one or more computational operations in an analog domain, which may provide attendant benefits, such as before conversion to a digital domain.

Some aspects include fabricating one or more circuits to perform one or more operations including the above-mentioned aspects.

Some aspects include a tangible, non-transitory, machine-readable medium storing instructions that when executed by a data processing apparatus cause the data processing apparatus to perform one or more operations including the above-mentioned aspects.

Some aspects include a system, including: one or more processors; and memory storing instructions that when executed by the processors cause the processors to effectuate one or more operations of the above-mentioned aspects.

### BRIEF DESCRIPTION OF THE DRAWINGS

The above-mentioned aspects and other aspects of the present techniques will be better understood when the present application is read in view of the following figures in which like numbers indicate similar or identical elements:

FIGS. 1A and 1B illustrate the representative chip stack and computing flow of the first convolution layer utilizing our proposed neuromorphic P²M architecture, in accordance with one or more embodiments.

FIGS. 2A-2F illustrate positive and negative weight realization with transistors for each DVS pixel's output channel, in accordance with one or more embodiments.

FIGS. 3A and 3B represents the output voltage change on the accumulation capacitor (ΔV_{OUT}) as a function of the normalized weight transistor'W/L ratios and different numbers of input event spikes, in accordance with one or more embodiments.

FIG. 4 depicts a multi-channel per DVS pixel architecture, in accordance with one or more embodiments.

FIGS. 5A-5B depict a neuromorphic P²M array block diagram with peripheral control circuits and multi-channel configuration of the proposed Neuromorphic P²M architecture, in accordance with one or more embodiments.

FIG. 6 illustrates an asynchronous convolution and output activation spike generation example of the proposed Neuromorphic P²M using the GF22nm FD-SOI technology node considering random inputs and weights, in accordance with one or more embodiments.

FIG. 7 depicts a representational diagram depicting an example AER read-scheme for the proposed Neuromorphic P2M architecture, in accordance with one or more embodiments.

FIG. 8 depicts a representative schematic showing a heterogeneously integrated system featuring Neuromorphic P2M paradigm utilizing Cu2Cu bonding, in accordance with one or more embodiments.

FIG. 9 depicts a graph showing a scatter plot with standard deviation comparing the pixel output voltage to ideal multiplication value of Weights×Input activation (Normalized W×I), in accordance with one or more embodiments.

FIG. 10 depicts a graph showing a plot of 100 random HSpice simulation results for 3×3 kernel benchmarking with the fitted equations, in accordance with one or more embodiments.

FIGS. 11A-11B depict graphs showing plots of comparison of the energy consumption between baseline and P²M implementations of SNNs to process neuromorphic images from (a) DVS128-Gesture, and (b) NMNIST datasets, in accordance with one or more embodiments.

FIG. 12 is a system diagram that illustrates an example computing system comprising processing in pixel, in accordance with one or more embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the fields of image processing. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

The description that follows includes example systems, methods, techniques, and operation flows that illustrate aspects of the disclosure. However, the disclosure may be practiced without these specific details. For example, this disclosure refers to specific types of computational circuits (e.g., analog multiply and accumulate (MAC), integrators, dot product, correlated double sampling (CDS), single-slope ADCs (SS-ADCs), comparators, etc.), specific types of processing operations (i.e., convolution, normalization, etc.), specific types of machine learning models (spiking neural networks (SNNs), convolutional neural networks (CNNs), encoder, autoencoders, etc.), and specific types of sensors (dynamic vision sensors (DVS), photosensors, etc.) in illustrative examples. Aspects of this disclosure can instead be practiced with other or additional types of circuits, processing operations and machine learning models. Further, well-known structures, components, instruction instances, protocols, and techniques have not been shown in detail to not obfuscate the description.

An asynchronous processing-in-pixel paradigm (herein referred to as “Processing-in-Pixel-in-Memory” or P²M paradigm) may be used to perform convolution operations by integrating multi-bit multi-channel weights inside the pixel array using analog multiply and accumulate (MAC) blocks. The P²M paradigm may improve energy efficiency compared to traditional digital MACs, such as due to decreased processing requirements and data transfer distances. A modeled circuit for the P²M paradigm, which may account for the circuit's non-ideality, leakage, and process variations, may show that, based on HSpice simulations using the GF22nm FD-SOI technology node, the P²M paradigm may be robust to physical non-linearities. The P²M paradigm, as verified on a Neuromorphic Vision Sensor dataset and a hardware-algorithm co-design framework, may consume 1.95× lower energy on IBM DVS128-Gesture dataset compared to the state-of-the-art with 88.36% test accuracy—e.g., may provide energy efficiency without sacrificing substantial accuracy.

A neuromorphic P²M paradigm may be used to enable massively parallel analog convolution over both space and time (e.g., spatiotemporal), including with a DVS array. The P²M paradigm may demonstrate image detection and processing which is not frame based (e.g., not based on a per image frame operation), but rather which is event (e.g., event-detection triggered) or difference (e.g., image change) based. The P²M paradigm may therefore create a sparse detection apparatus (e.g., corresponding to event occurrences rather than per frame), which may reduce memory, bandwidth, etc. requirements. The P²M paradigm may also integrate weighting, such as corresponding to one or more layers of a SNN or other neural network, into the sensor environment, which may improve inference, detection, and other operations performed on the output of a neuromorphic (or other) camera. None of which is to suggest that any technique suffering to some degree from these issues or other issues described in the previous paragraphs is disclaimed or that any other subject matter is disclaimed.

Some embodiments may implement the techniques and/or devices (in part or in full) described in U.S. Provisional Application 63/302,849, titled “Embedded ROM-based Multi-Bit, Multi-Kernel, Multi-Channel Weights in Individual Pixels for Enabling In-Pixel Intelligent Computing,” filed 25 Jan. 2022, the contents of which are hereby incorporated by reference in their entirety.

Some embodiments may implement the techniques and/or devices (in part or in full) described in WIPO Patent Application PCT/US2023/011531, titled “Embedded ROM-based Multi-Bit, Multi-Kernel, Multi-Channel Weights in Individual Pixels for Enabling In-Pixel Intelligent Computing,” filed 25 Jan. 2023, the contents of which are hereby incorporated by reference in their entirety.

Some embodiments may implement the techniques and/or devices (in part of in full) described in U.S. Provisional Application 63/395,725, titled “IRIS: Integrated Retinal Functionality in Image Sensors,” filed 5 Aug. 2022, the contents of which are hereby incorporated by reference in their entirety.

Some embodiments may implement the techniques and/or devices (in part of in full) described in WIPO Patent Application PCT/US2023/071788, titled “IRIS: Integrated Retinal Functionality in Image Sensors,” filed 7 Aug. 2023, the contents of which are hereby incorporated by reference in their entirety.

Some embodiments may implement the techniques and/or devices (in part or in full) described in U.S. Provisional Application 63/433,592, titled “Peripheral Circuits for Processing-in-Pixels,” filed 19 Dec. 2022, the contents of which are hereby incorporated by reference in their entirety.

Some embodiments may implement the techniques and/or devices (in part of in full) described in U.S. patent application Ser. No. 18/545,859, titled “Peripheral Circuits for Processing-in-Pixels,” filed 19 Dec. 2022, the contents of which are hereby incorporated by reference in their entirety.

Some embodiments may implement the techniques and/or devices (in part of in full) described in Datta, G., Kundu, S., Yin, Z. et al. A processing-in-pixel-in-memory paradigm for resource-constrained TinyML applications. Sci Rep 12, 14396 (2022). https://doi.org/10.1038/s41598-022-17934-1, the contents of which are hereby incorporated by reference in their entirety.

Some embodiments may implement the techniques and/or devices (in part of in full) described in Abdullah-Al Kaiser, Md., Datta, G., Wang, Z. et al. Neuromorphic-P²M: Processing-in-Pixel-in-Memory Paradigm for Neuromorphic Image Sensors. Front. Neuroinform., 4 May 2023 (17) https://doi.org/10.3389/fninf.2023.1144301, the contents of which are hereby incorporated by reference in their entirety.

Much image processing is energy and bandwidth intensive, including image detection, processing, identification, etc. based on pixel values or values from other image sensors. By applying neuromorphic principles to image acquisition (and processing), such as by using difference detectors—such as DVSs—the amount of pixel values may be reduced which may simplify processing. For example, by selecting from a set of pixel values (or other values corresponding to sensors) only pixel values which change (e.g., over an interval), the number of pixel values upon which a computation (e.g., inference, detection, etc.) may be based may be reduced. In some embodiments, detection events may include additional information, such as direction of a pixel value (or light) change (e.g., brighter, darker, more red, less red, etc.). In some embodiments, detection events may be binary—e.g., an event was detected or not—and may not include information about the direction, magnitude, etc. of the change which resulted in the detection event.

In example embodiments, an image sensor may include a monolithic (or homogeneously) integrated sensor array, which may further include integrated weighting elements, such as weighting transistors. The sensor array, which may be a backside CMOS image sensor (CIS), may include integrated transistors electrically connected to outputs of the sensors. The sensors may be diodes, transistors, etc. which may include photodiodes, optically excited channel material, or any other appropriate sensor. The output associated with the transistor may be weighted (e.g., increase in voltage, charge, etc.) by one or more weighting elements. The weighting elements may be transistors, diodes, etc. The weighting elements may be selected by one or more select lines, including select lines which correspond to one or more kernel. In some embodiments, each kernel may correspond to a set of weighting elements, and activation of a given kernel may correspond to activation of its corresponding weighting elements.

In some embodiments, an array of sensors, which may be DVSs, may correspond to an array of sensor outputs, where each sensor may have an “ON” and an “OFF” output, or other appropriate outputs, for example “low ON”, “high ON”, “low OFF”, “high OFF”, etc. The sensors of the array may be triggered, such as by detection events, including asynchronously. The weighting elements, which may have different values, may be applied to output of the sensor(s). Because the sensor(s) may only have a non-zero (or changing) output when a detection event occurs, the output of the sensor may be weighted asynchronously in some embodiments. In some embodiments, the sensor may have a non-zero baseline output, such as a median voltage output, when no event is detected, and then have a high output for an ON event and a low output for an OFF event detection. Multiple sensors, such as multiple sensors corresponding to a given kernel, may provide output (e.g., weighted output), to an accumulation element, which may be a capacitor or any other appropriate accumulation circuit. The accumulation element may accumulate signals, including weighted signals, from the sensors of the kernel, over an accumulation time. In some embodiments, the accumulation element may experience an increase in accumulation as a result of an ON event and a decrease in accumulation as a result of an OFF event. The accumulation element may accumulate voltage, charge, current, etc. In some embodiments, the accumulation element, at the end of the accumulation time, may have acquired a voltage (or charge, etc.) corresponding to the total number (e.g., summation) of ON events and the total number of OFF events (e.g., to the total number of events). Alternatively, the accumulation element may have acquired a voltage corresponding to the difference between the total number of ON events and the total number of OFF events (e.g., to the total difference in ON versus OFF events). In some embodiments, the accumulation element may be thresholded—e.g., the acquired voltage may be compared to a threshold to determine if a number of events which exceed a threshold have occurred. In some embodiments, the accumulation element may be reset, such as to a baseline, such as ½ V_{dd}, to a zero baseline, etc. after the accumulation time.

As the amount of data acquired and processed by on-edge intelligent machine vision applications increase, energy-efficient computing solutions have become sought after to process this vast amount of sensory data. Different approaches in energy-efficient computing have been explored, such as near-sensor processing, in-sensor processing, and in-pixel processing, which may bring the computation closer to the sensor. In-pixel processing embeds the computation capabilities inside the pixel array and may exhibit higher energy efficiency by generating low-level features at the pixels themselves instead of the raw data stream typically produced by CMOS Image Sensors. Many different in-pixel processing techniques and approaches have been demonstrated on conventional frame-based CMOS imagers, however, the processing-in-pixel approach for asynchronous Neuromorphic Vision Sensors has had less attention. In some embodiments, an asynchronous processing-in-pixel paradigm is produced which may perform convolution operations by integrating multi-bit multi-channel weights inside the pixel array using analog multiply and accumulate (MAC) blocks, which may improve energy efficiency compared to traditional digital MACs. In some embodiments, such as to make this approach viable, the circuit's non-ideality, leakage, and process variations have been incorporated into an algorithmic framework, as shown by performing extensive HSpice simulations using the GF22nm FD-SOI technology node. For some embodiments, it have been verified that the proposed processing-in-pixel paradigm on Neuromorphic Vision Sensor datasets and with an accompanying hardware-algorithm co-design framework may consume 1.95× lower energy on IBM DVS128-Gesture dataset compared to the current state-of-the-art with 88.36% test accuracy.

Many of today's widespread video acquisition and interpretation applications are fueled by CMOS Image Sensors (CIS) and deep learning algorithms. However, these computer vision systems may suffer from energy efficiency and throughput bottlenecks that may stem energy costs associated with the transmission of a high volume of data between the sensors at the edge and processors in the cloud. For example, smart glasses (e.g., Meta AR/VR glasses, google classes, etc.) may drain their own battery within 2-3 hours when used for intensive computer vision tasks. Although there have been technological and system-level advancements in both CMOS imagers and deep neural networks, the underlying energy inefficiency may arise due to the physical segregation between sensory and processing hardware. Because of these drawbacks, developing novel energy-efficient hardware for resource-constrained computer vision applications has been identified as an areas for further research.

Some techniques may reposition the first few computation tasks of the machine vision applications closer to the sensor (e.g., from a separate processor to the sensor) to reduce the energy consumption associated with massive data transfer. These approaches may be categorized into three types (1) Near-Sensor Processing, (2) In-Sensor Processing, and (3) In-Pixel Processing. In the near-sensor processing approach, the digital signal processors or machine learning accelerators may be placed close to the sensor chip. In some instances, the inclusion of the near-sensor processor along with an existing edge processor exhibited 64.6% MobileNetV3 inference energy reduction. In another example, a 3D stacked CNN inference processor a backside back-side illuminated CMOS image sensor reported 4.97 Tera Operations Per Second per Watt (TOPS/W) energy efficiency. Enabling near-sensor computing may improve energy consumption by reducing data transfer costs from the sensor chip to a cloud or edge processor, however, near-sensor computing may still suffer from the energy burden of the data traffic between the sensor and near-sensor off-chip processor.

In contrast, an in-sensor approach may utilize an analog or digital signal processor at the periphery on the same sensor chip. For example, analog convolution processing may be used before a sensor's analog-to-digital conversion blocks to obtain a reported a 5.5× reduction in sensor energy. In another example, a current-mode analog low-precision Binary Neural Network (BNN) using energy efficient analog computing has been proposed. In another example, raw analog data from a CMOS image sensor was processed using an on-chip switched-capacitor-based analog BNN that avoids the analog-to-digital conversion steps. In an example, energy-efficient current-domain on-chip MAC operation have been implemented. In addition, mixed-mode in-sensor Tiny Convolution Neural Network (CNN) has reported a significant data workload reduction before the ADC operation. However, this solution may still require that raw analog data to be streamed through column-parallel bitlines from the sensor nodes to the peripheral processing networks. This approach may significantly reduce the energy overhead of analog-to-digital converters, however, the data transfer bottleneck from the sensor to peripheral processors or accelerators may still be present.

On the other hand, the in-pixel processing approach may integrate computation capabilities inside the pixel array to enable early processing that minimizes the data transmission bandwidth. For instance, in an example, a low-voltage in-pixel convolution operation may utilize the current DAC as weights along with linear-response pulse width modulation (PWM) pixels. In another example, a Single Instruction Multiple Data (SIMD) Pixel Processor Array (PPA) may perform different convolution operations in parallel inside the pixel array by storing the weights of the convolution filter in the in-pixel processing element's registers. In an example, direct utilization of the photodetector current to compute the binary convolution may exhibit 11.49 TOPS/W energy efficiency. In another example, classification tasks on the MNIST dataset may be performed by generating the in-pixel MAC results of a first BNN layer and may exhibit 17.3 TOPS/W energy efficiency. In another example, a processing-in-pixel-in-memory paradigm for CIS reported up to 11× energy-delay product (EDP) improvement on Visual Wake Words (VWW) dataset. Follow-up works have demonstrated up to 5.26× and 3.14× reduction in energy consumption on hyperspectral image recognition and multi-object tracking in the wild, respectively. In some embodiments, due to the embedded pixel-level processing elements, the in-pixel processing approach may outperform energy and throughput compared to the in-sensor and near-sensor processing solutions.

Some of current research on different energy-efficient CIS approaches (near-sensor, in-sensor, and in-pixel processing) may focus on conventional frame-based imagers. However, other research may explore the event-driven neuromorphic camera or Dynamic Vision Sensor (DVS) for different neural network applications, such as autonomous driving, steering angle prediction, optical flow estimation, pose re-localization, lane marker extraction, etc., due to its energy, latency and throughput advantages compared to traditional CMOS imagers. The DVS pixel may generate event spikes based on a change in light intensity instead of sensing the absolute pixel-level illumination like conventional CMOS imagers. Thus, DVS pixel may filter out the redundant information from a visual scene and produces useful sparse asynchronous events. Those sparse events may be communicated off-chip utilizing the address event link. Due to abandoning the analog-to-digital conversion of the absolute pixel intensity and frame-based sensing method, DVS may exhibit higher energy efficiency, lower latency, and higher throughput in us temporal resolution. Moreover, the dynamic range of the DVS pixel may be higher than the conventional CMOS imagers, hence, the DVS camera may be able adapt to the illumination level of the scene due to its logarithmic receptor. Owing to the advantages in energy, latency, throughput, and dynamic range, the neuromorphic vision sensor may represent a paradigm shift in efficient perception and vision-based applications. Typically, in the spiking convolutional neural network model, a first layer may consist of digital MAC elements (and may not consist of accumulators since the input is a multi-bit value instead of a binary activation) and the subsequent layers may consist of accumulators. Hence, to further improve the energy efficiency of the neuromorphic vision sensory system, an in-pixel processing solution in one or more embodiments has been explored to enable massively parallel MAC operations inside the pixel array. None of which is to suggest that any technique suffering to some degree from these issues or other issues described in the previous paragraphs is disclaimed or that any other subject matter is disclaimed.

In some embodiments, a energy-efficient processing-in-pixel-in-memory (P²M) computing paradigm has been developed for the Neuromorphic Image Sensors. In some embodiments, a first convolutional layer of the neural network model may be implemented by embedding multi-bit multi-channel weights across the pixel array to enable massively parallel in-pixel spatio-temporal MAC operations. The DVS event spikes may be asynchronous in nature, therefore, multiply operation may need to be performed simultaneously across different channels of the same spatial feature map and accumulation continued for a fixed temporal window throughout the pixel array. The charge-based in-pixel analog MAC operations may exhibit higher energy efficiency compared to their digital off-chip counterpart. Moreover, the sparse binary output activations of the first layer may be communicated utilizing an address-event-representation (AER) link, hence, preserving the energy benefit of the workload sparsity. In addition, in some embodiments, a hardware-algorithm co-design framework may be developed incorporating the circuit's non-linearity, process variation, leakage, and area consideration, such as by using the GF22nm FD-SOI technology node. For some embodiments, the feasibility of the hardware-algorithm framework may be demonstrated utilizing neuromorphic event-driven datasets (e.g., IBM DVS128-Gesture, NMNIST) and performance and energy improvement of the P²M approach may be evaluated. In some embodiments, a ˜5% accuracy drop may occur in these datasets since any membrane potential may be neglected—e.g., the state variable in the P²M layer that may retain the rich temporal information in the DVS datasets. The lack of membrane potential may be due to the inability of the charge-retaining capacity of the analog passive capacitors in the P²M implementation. This problem, however, may be mitigated using non-volatile memories in some embodiments.

In some embodiments, the P²M paradigm may have one or more of the following properties:

A novel neuromorphic-processing-in-pixel-in-memory (Neuromorphic-P²M) paradigm for neuromorphic image sensors, wherein, multi-bit pixel-embedded weights may enable massively parallel spatio-temporal convolution operation on input events inside the pixel array.

A charge-based energy-efficient in-pixel asynchronous analog multiplication and accumulation (MAC) units and which may incorporate the non-idealities, and process variations of the analog convolution blocks into an algorithmic framework.

A hardware-algorithm co-design framework which may consider hardware constraints (non-linearity, process variations, leakage, area consideration). In some embodiments, the accuracy may be benchmarked to yield up to a 1.95× improvement on the IBM DVS128-Gesture dataset with a ˜5% drop in test accuracy.

Further sections may illustrate the circuit implementation, operation, and manufacturability of the proposed Neuromorphic—P2M approach, in some embodiments. Additional sections may explain a hardware-algorithm co-design approach and hardware constraints on the first layer of the neural network model, used in some embodiments. Additionally, experimental results are provided on two different event-driven DVS datasets, and the P2M paradigm evaluated under accuracy and performance metrics.

### The P²M Paradigm

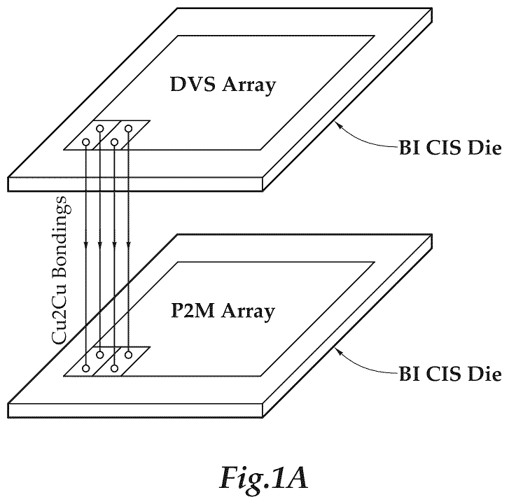

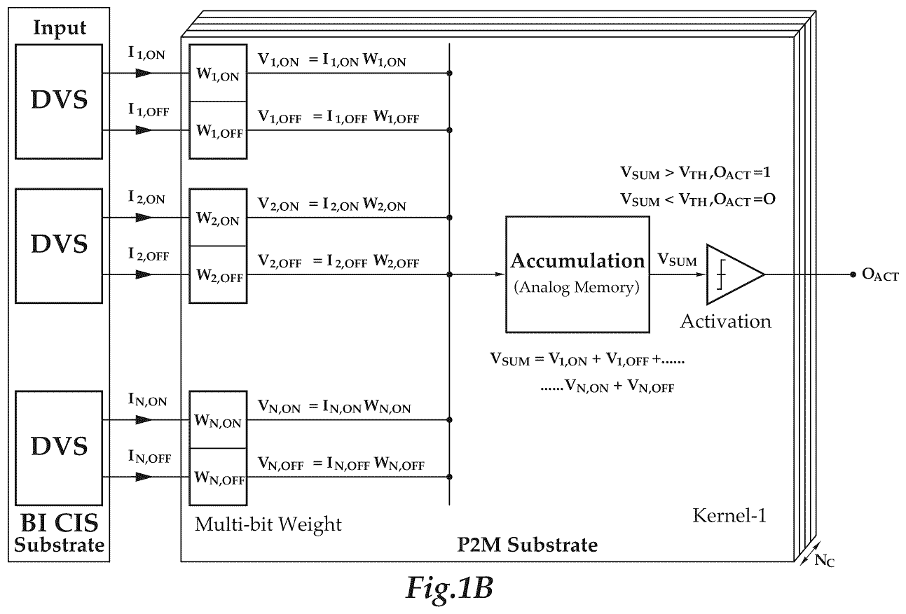

In some embodiments, various hardware innovations and implementations are combined for the proposed neuromorphic—P²M approach. FIGS. 1A and 1B illustrate the representative chip stack and computing flow of the first convolution layer utilizing our proposed neuromorphic P²M architecture. FIGS. 1A and 1B depict the representative 3D chip stack and computing flow diagram of the proposed Neuromorphic P²M architecture, in one or more embodiments. The top die may consist of DVS pixels and generates either ON (OFF) events based on the increase (decrease) in contrast level. DVS pixel may consist of a logarithmic receptor, source-follower buffer, capacitive-feedback difference amplifier, two comparators, etc. The generated events (ON and OFF) per pixel may be communicated to the bottom die via pixel-level hybrid Cu-to-Cu bondings or any other appropriate pixel level bonding. The bottom die may contain the weights (e.g., weighting elements) and energy-efficient charge-based analog convolution blocks, or any other appropriate processing circuitry. In some embodiments, each DVS pixel's output channel (ON-channel and OFF-channel) may be connected to a transistor in the bottom die that implements multi-bit weights (e.g., w_{1,ON}, w_{1,OFF}, etc.) to perform the weighted-multiplication (e.g., I_{1,ON}×w_{1,ON}, I_{1,OFF}×w_{1,OFF}, etc.) operation. The positive and negative weights may be implemented by utilizing the pMOS and nMOS transistors, respectively. In some embodiments, each kernel (corresponds to the filter of the deep neural network model) may accumulate its weighted multiplication of input events on an analog memory (such as a capacitor) asynchronously when an ON or OFF event occurs in the input DVS pixel. As the input spikes may be binary, the accumulation voltage may either step up (such as in response to a positive weight) or down (in response to a negative weight) by an amount, which may depend on the weight values. The accumulation may continue for a fixed time period (e.g., for a simulation time length for each event stream of the neural network model) and after that, a summed voltage may be compared with a thresholding block (such as a comparator or skewed inverter) to generate an output activation signal (e.g., O_{ACT}) of each kernel for the next layer. In some embodiments, a similar computing flow and blocks may be used across the different kernels throughout the sensor array.

The operations of the proposed Neuromorphic P²M may be divided into three (or more or less) phases. These are:
Reset Phase: During the reset phase, the accumulation capacitor of each kernel may be precharged, such as to 0.5 V_{DD}, so that the accumulation voltage may step up or down within the supply rail depending on positive or negative weights, respectively.
Convolution Phase: In the convolution phase, the multi-bit weight embedded pixels and the accumulation capacitor of each kernel may continue to perform multiplication and accumulation (MAC) operations in the energy-efficient analog domain for a fixed period of time. After that, the final accumulated voltage of each kernel may be compared with a threshold voltage and may generates the output activation spike for the next layer.
Read Phase: Finally, during the read phase, the output activations of different kernels may be read utilizing the asynchronous Address-Event Representation (AER) read scheme, such as sequentially.

More details on each step including the hardware implementations will be explained in the following sections.

### Multi-Bit Weight Embedded Pixels

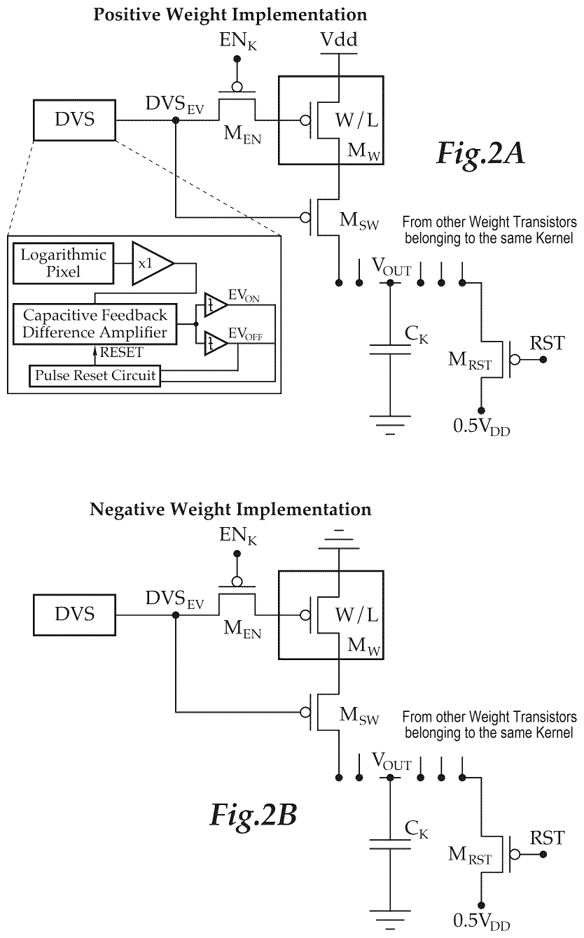

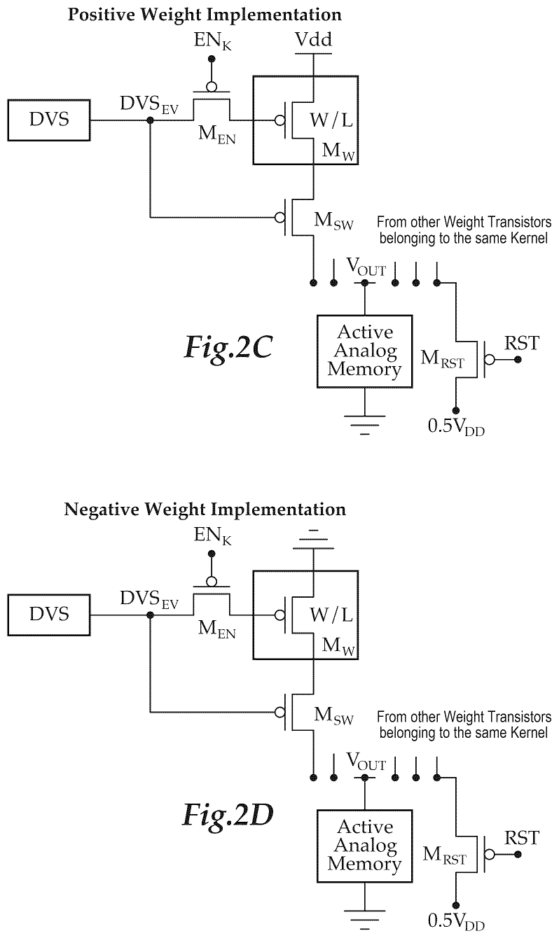

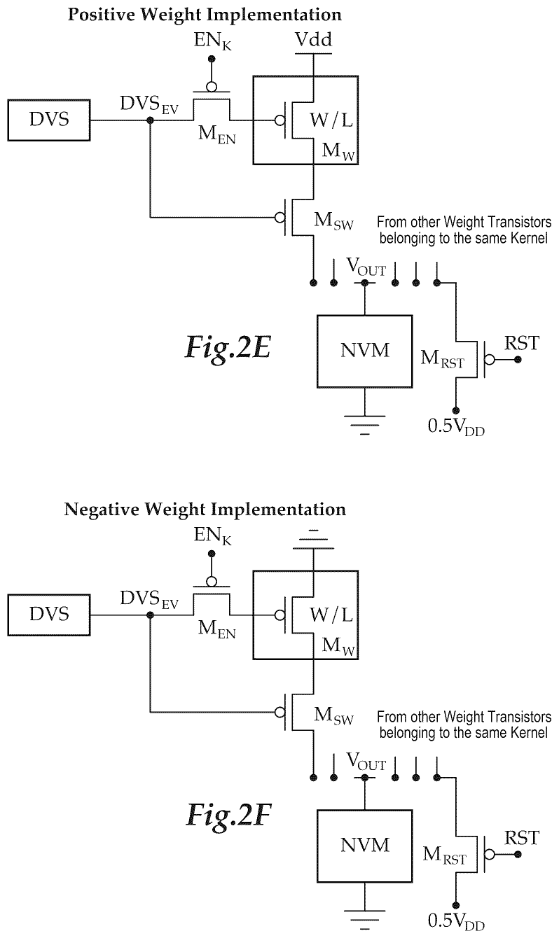

In some embodiments, positive and negative weights of the first CNN layer may be implemented by utilizing pMOS and nMOS transistors connected with supply voltages V_{DD} and ground, respectively. FIGS. 2A-2F illustrate positive and negative weight realization with transistors for each DVS pixel's output channel. FIGS. 2A-2F depict various accumulation elements for embedded multi-bit positive and negative weight implementations. FIGS. 2A-2B depict positive and negative weight implementations, respectively, for a capacitive accumulating circuity. FIGS. 2C-2D depict positive and negative weight implementations, respectively, with active analog memory circuitry for accumulation and/or value storage (e.g., in active memory). FIGS. 2E-2F depict positive and negative weight implementations, respectively, with non-volatile memory (NVM) circuitry for accumulation and/or value storage (e.g., in non-volatile memory). In some embodiments, such as those depicted in FIGS. 2C-2F, the accumulation elements may or may not include capacitive accumulation. For a positive (negative) weight the voltage across the kernel's capacitor (C_{K}) may charge (discharge) from 0.5 V_{DD} to V_{DD} (ground) as a function of weight values and the number of input DVS events. The weight values may be modulated by tuning the driving strength

$$( \frac{W}{L} ratio )$$

of the weight transistors (M_{W}). A high-V_{T} pMOS in positive weight implementation (nMOS in negative weight implementation) (M_{EN}) may be activated during the convolution phase to enable the multiplication and accumulation operations on the Kernel's capacitor (C_{K}) and may remain off during the reset phase. The weight transistor (M_{W}) may consist of a high-V_{T} transistor to limit the charging (for positive weight) or discharging (for negative weight) current, such as to avoid capacitor saturation. Moreover, each DVS pixel may include a delayed self-reset circuit (such as consisting of a current-starved inverter chain and AND gate) to ensure the short pulse width during the ON and OFF events to prevent voltage saturation. A switch transistor (M_{SW}) controlled by DVS event spikes may be used to isolate the kernel's capacitor (C_{K}) from the weight transistor (MW) to reduce the leakage. The switching transistor (M_{SW}) may be activated only when there are input DVS spikes, which may ensure that the asynchronous MAC operation occurs on the kernel's capacitor (C_{K}). In some embodiments, multiple weight transistors, which may depend on the size of the kernel (e.g., for a kernel size of 3×3, 18 weight transistors considering the ON and OFF-channel may be connected with one kernel-dedicated capacitor (C_{K})), may be connected with one accumulation capacitor in each kernel. During the reset phase, the reset transistor (M_{RST}) may precharge the capacitor node (V_{OUT}) of each kernel to 0.5 V_{DD} to make it ready for the next convolution phase. In some embodiments, the weights array may lack programmable features (e.g., after the manufacturing process), however, it may be sufficient to use pre-trained weights for the first few layers as low-level feature extractors in modern neural network models. Hence, the fixed weights of the proposed P²M architecture may be applicable for a wide class of machine-vision applications.

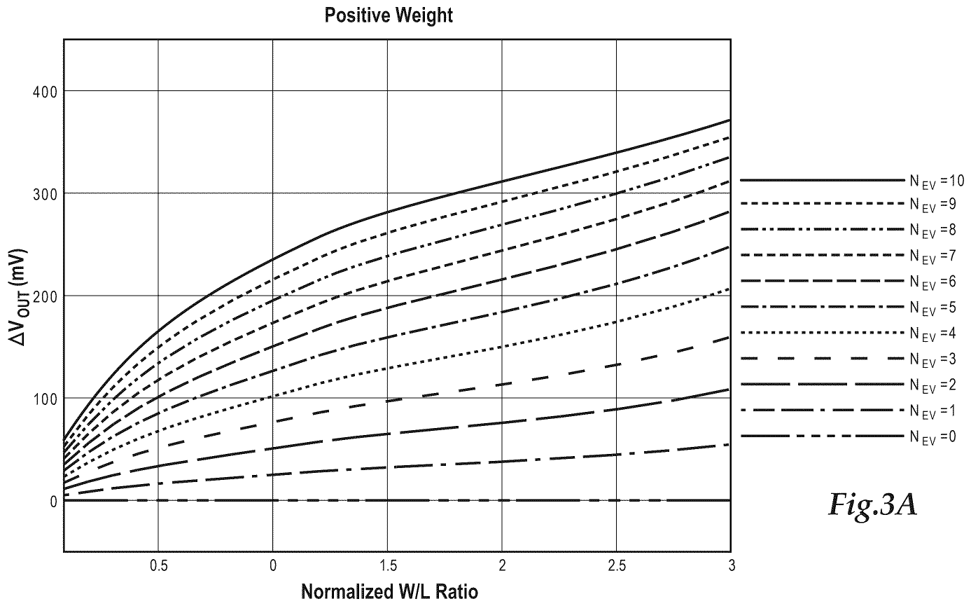

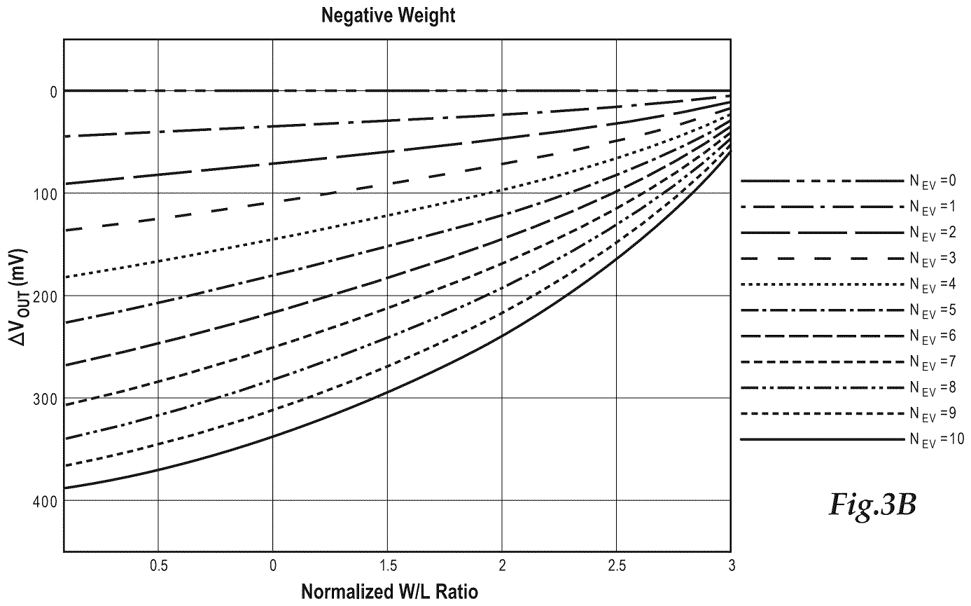

In some embodiments, in order to incorporate the actual circuit's nonideality in the algorithmic model, the output characteristics of the positive and negative weights may be simulated for the different numbers of input event spikes on the GF 22 nm FD-SOI node. FIGS. 3A and 3B represents the output voltage change on the accumulation capacitor (ΔV_{OUT}) as a function of the normalized weight transistor's-ratios and different numbers of input event spikes. FIGS. 3A and 3B depict output accumulation voltage change (ΔV_{OUT}) from the reset voltage of the kernel capacitor (C_{K}) as a function of normalized weight (normalized transistor

$$\frac{W}{L} ratio )$$

and input event spikes simulated on GF 22 nm FD-SOI node for positive and negative weights. From the figures, it may be observed that the accumulation voltage steps may be increasing (decreasing) for positive (negative) weights with the increase in weight values (weight transistor's and

$$\frac{W}{L} ratios )$$

the number of input event spikes. However, the output voltage characteristics may be non-linear, and non-linearity may become higher for large weight values and a large number of input spikes. It may be clearly depicted as the weight transistor enters into the triode region due to low V_{DS} across the weight transistor (M_{W}) when accumulation voltage on the capacitor node (V_{OUT}) becomes closer to V_{DD} or GND for positive or negative weights, respectively. Due to the entering into the triode region of the weight transistor, the charging (discharging) current may become smaller than the saturation current for positive (negative) weight implementation, hence, accumulation steps may become saturated. However, the number of input events may be sparse for the DVS dataset, and having large weight values for all the weights in a kernel may be relatively unlikely for a neural network model. Hence, in some embodiments, non-linear characteristics of the weight transistors may not cause any significant accuracy issues in the algorithmic model. In addition, in some embodiments, the circuit's asymmetry due to utilizing different types of transistors (pMOS for positive weights and nMOS for negative weights) may also be captured and included in the algorithmic model.

### In-Situ Multi-Pixel Multi-Channel Convolution Operation

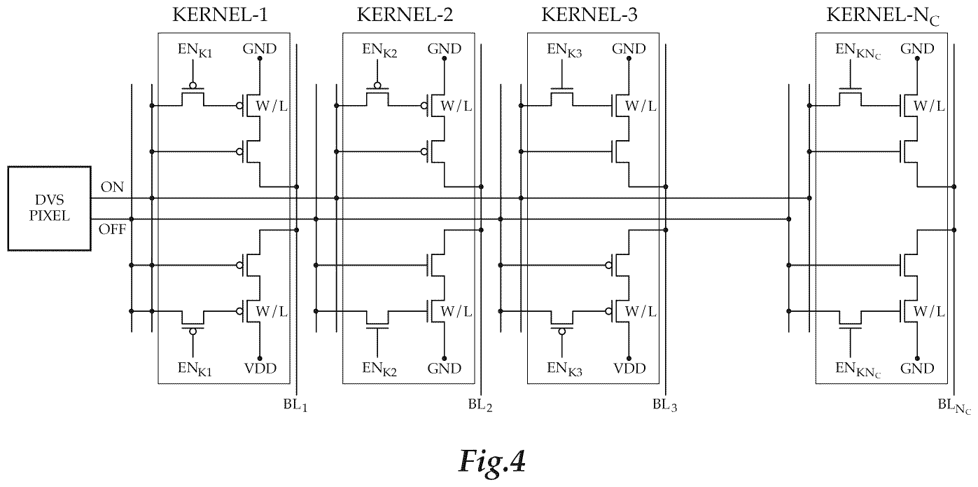

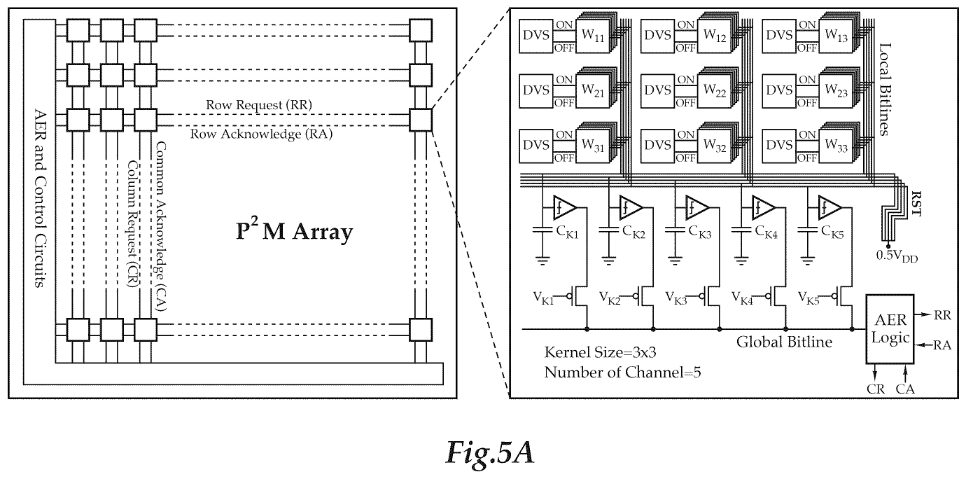

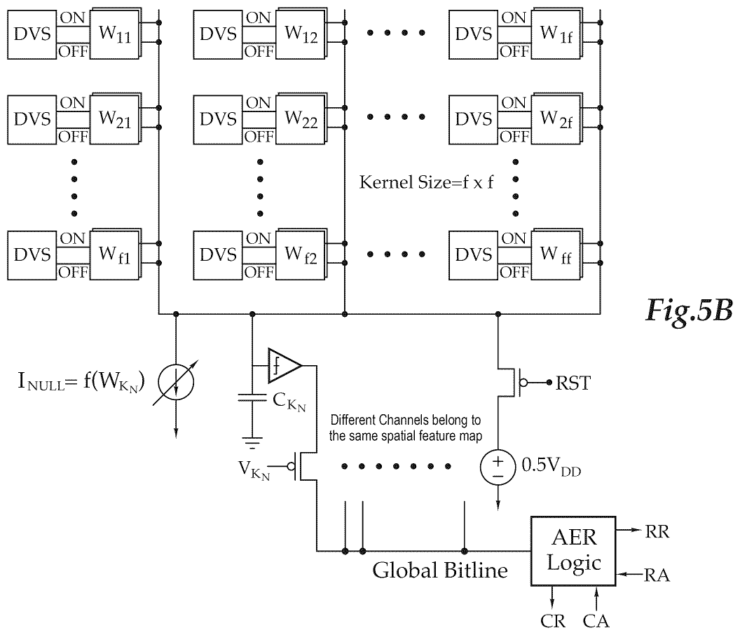

In some embodiments, in the first CNN layer, spatio-temporal MAC operations may be performed across multiple channels substantially simultaneously for each kernel. FIG. 4 depicts a multi-channel per DVS pixel architecture. In FIG. 4, the DVS pixel may output signals to multiple kernels (e.g., kernels 1-N_{C}) by both ON and OFF signal lines. Each kernel may have a bitline, which may be adjusted in value by output of positive and negative weighting operations corresponding to the DVS output. FIGS. 5A-5B illustrate the proposed Neuromorphic P²M architecture. FIGS. 5A-5B depict a neuromorphic P²M array block diagram with peripheral control circuits and multi-channel configuration of the proposed Neuromorphic P²M architecture. The left sub-figure of FIG. 5A represents an array of analog MAC blocks (white rectangular boxes) consisting of multiple channels distributed spatially. In some embodiments, each DVS pixel may be connected with multiple weight transistors of the analog MAC blocks depending on the number of channels and stride (e.g., each DVS pixel may be connected with four sets of analog MAC blocks for the stride of 2). In some embodiments, each channel may perform analog MAC operations asynchronously for a fixed temporal window (e.g., with a length of each algorithmic time step). For instance, if it is assumed that the kernel size is 3×3 and each kernel has 5 different channels that are represented by the white rectangular boxes in the left sub-figure of FIG. 5A, then the right sub-figure of FIG. 5A exhibits the detailed version of the 3×3 kernel with 5 different channels. In some embodiments, each channel may have a dedicated accumulation capacitor (e.g., C_{Ki}, where i=1, 2, . . . 5, etc.) and local bitline so that charge may accumulate across the different channels (e.g., across substantially all the different channels) at the same time. Depending on the kernel size, multiple weight transistors (both positive and negative) may be connected with its kernel-dedicated accumulation capacitor using the local bitline in each channel. In the view of FIG. 5A, 18 weight transistors (kernel size=3×3 and for ON and OFF-channel of the DVS pixels) are connected with a single kernel capacitor. In some embodiments, per channel accumulation capacitor and local bitline may be shared among the kernel's weight transistors, such as to ensure simultaneous and massively parallel spatio-temporal MAC operations across different channels. The weighted multiplications (e.g., fixed amount of charge transfer to kernel capacitor from V_{DD} for positive weight or from kernel capacitor to GND for negative weight depending on the sign of the weight values) may continue to accumulate for the fixed time (e.g., the length of each algorithmic time step). In some embodiments, these analog MAC operations may be asynchronous and parallel across the kernels (e.g., across substantially all the kernels) for all the input feature maps (DVS pixels) throughout the sensor array. Finally, in some embodiments, a thresholding circuit may compare the final accumulated voltage on each channel's capacitor (or other accumulation circuitry) with a reference voltage to generate the output activation spike. In some embodiments, output activations from different channels may be multiplexed (controlled by V_{K1}, V_{K2}, etc.) to communicate with AER read circuits at the periphery (e.g., as depicted in the left sub-figure of FIG. 5A) through kernel-level AER logic block (e.g., as depicted in the right sub-figure of FIG. 5A). In some embodiments, the row request (RA) and row acknowledge (RA) signals (e.g., of the AER protocol) may be shared along the rows and the column request (CR) and column acknowledge (CA) signals may be shared along the columns. After the read operation (described in more detail in a further section), in some embodiments, the kernel's accumulation capacitor may be reset to 0.5 V_{DD}. Note, the reset operation may imply that there is no propagation (e.g., substantially no propagation) of the voltage accumulated on the kernel's capacitor from one time step to subsequent time steps in some embodiments. Thus, the kernel capacitor voltage may be unlike a typical representation of the membrane potential, where the membrane potential may be conserved across time steps. Taking into account the above behavior, in some embodiments, for the first layer of the network, the algorithmic framework may include thresholding and reset operation across time steps, thus representing the circuit behavior in algorithmic simulations. In some embodiments, the frequency of the reset operation may be based on the amount of time the capacitor can hold the charge without significant leakage (e.g., based on the memory permanence time of the capacitor or other accumulation circuitry). To minimize the capacitor leakage, in some embodiments one or more of the following elements may be used: a high-V_{T} weight transistors; a switching transistor (M_{SW} in FIGS. 2A-2F) to disconnect the kernel capacitor from weights; and a kernel dependent current source connected with the accumulation capacitor that flows in the opposite direction of the leakage current to nullify the leaky behavior of the capacitor. According to HSpice simulations of one or more embodiment, in a relatively worst-case scenario (where all weights are maximum in the kernel, which may be very unlikely in the neural network model and its inherent weightings), the voltage on the accumulation capacitor may deviate due to leakage from its ideal value by a mere 22 mV over a significantly longer duration of time (e.g., 1 ms). Based on the reset frequency, the length of each algorithmic time step of the neural network model has been set to 1 ms for the first layer in the simulations discussed herein.

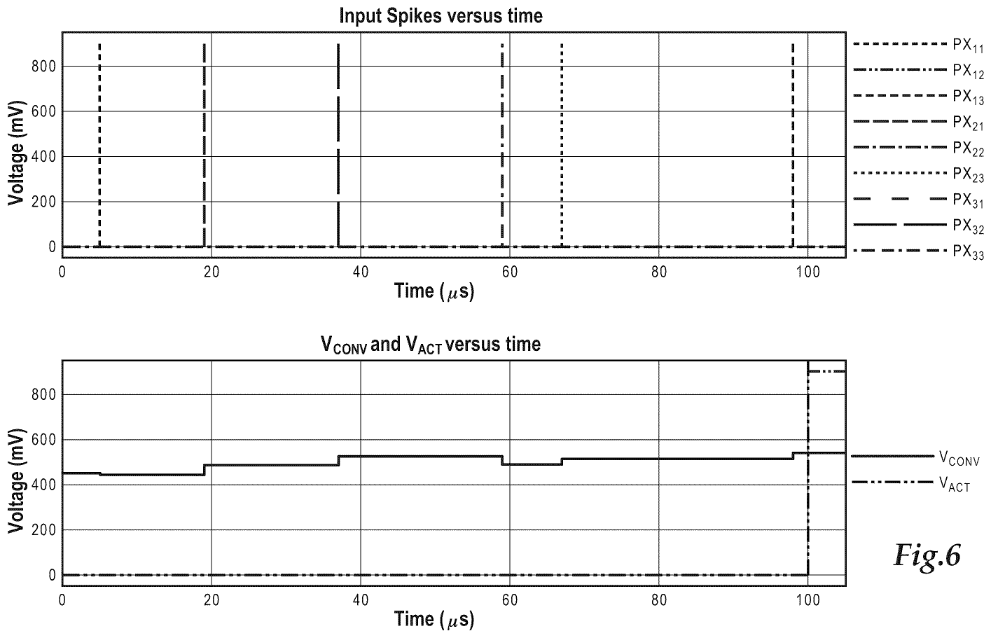

FIGS. 6 illustrates an asynchronous convolution and output activation spike generation example of the proposed Neuromorphic P²M using the GF22 nm FD-SOI technology node considering random inputs and weights. FIG. 6 depicts graphs showing a random convolution operation with output activation spike simulated on GF 22 nm FD-SOI node. For the simulation depicted, a kernel size of 3×3 has been considered. The weights, the instant of the events, and the number of events per DVS pixel have been generated randomly. For the test simulation, 100 μs simulation time length for each event stream has been considered, hence, all the output events from DVS pixels within this time period may be multiplied with their weights and accumulated on the kernel's accumulation capacitor before being compared with a fixed threshold voltage. The top subplot shows that the DVS pixels (e.g., PX₁₁, PX₂₁, etc.) are generating the event spikes at different time instants. PX₁₃, PX₂₁, PX₂₃, PX₃₂ are connected with positive weights, whereas the other pixels are connected with negative weights. It may also be noted that some pixels (e.g., PX₁₂, PX₂₂, PX₃₁) do not generate any event during this time frame. These no-event generation scenarios are also considered in this test simulation to mimic actual dataset sparsity. From the bottom subplot, it can be observed that the convolution output (V_{CONV}) of the analog MAC circuit is updating (charging or discharging) for each input event spike. When the weight is positive (negative), the accumulation voltage steps up (down) depending on the weight value throughout the simulation time length for each event stream. Finally, in some embodiments, after the fixed time (e.g., 100 μs in this example test simulation), the convolution output may be compared with the threshold voltage. In some embodiments, if the convolution output is higher than the threshold voltage, the comparator will generate an output activation spike (V_{ACT}) for the next layer for each kernel.

### P²M Address-Event Representation (AER) Read Operation

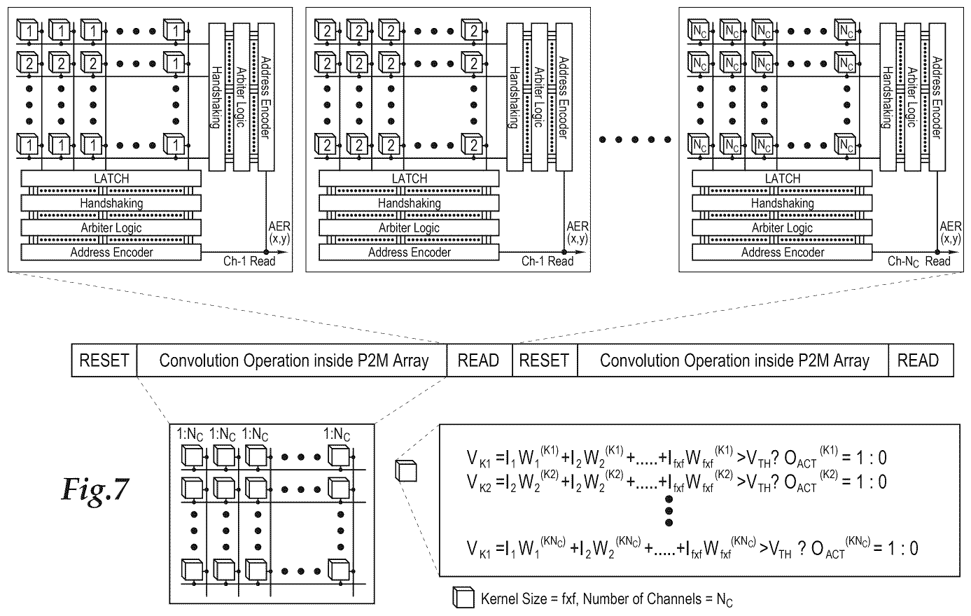

In some embodiments, the asynchronous AER read-out scheme may be used to read the output activations from the first convolution layer. The representative read scheme diagram is illustrated in FIG. 7. In FIG. 7, a representational diagram depicts an example AER read-scheme for the proposed Neuromorphic P²M architecture. In some embodiments, the P²M architecture may support multiple numbers of channels (e.g., N_{C}) similar to the CNN model. The outputs of the channels (thresholded output activation spikes) may be being read sequentially throughout the P²M array, including in an asynchronous manner. At a time, one channel may be asserted in the P²M array by activating V_{Ki} sequentially, where, i=1, 2, . . . N_{C} (shown in FIG. 5A). In some embodiments, kernel-level AER logic block may be shared among different channels for each spatial feature map, where the AER logic blocks may generate row and column request signals whenever there is an output activation spike in the kernel. In some embodiments, for AER reading, row-parallel techniques may be used where all (e.g., substantially all) the events generated in a single row are latched and then read sequentially. In some embodiments, the peripheral address encoders (e.g., row and column encoders) of the AER read circuits may output the x and y address of the output activation in parallel. Moreover, while doing the read operation, the next reset and convolution phases may be pipelined without waiting for the read phase to be completed, for example by adding a transistor between the kernel capacitor and the comparator. In some embodiments, the comparator output may be stored on the dynamic node for a short period of time or even a small holding capacitor may be used to hold the output activation for a sufficient amount of time considering the read operation. In some embodiments, as the output activations may be sparse and the AER read may be completed within a few us windows, the architecture may be used to perform the convolution and read phase in parallel. In some embodiments, the output activation map size may be reduced as a function of the kernel size and number of strides due to performing the in-pixel convolution operation. In addition, in some embodiments, an extra bit may not need to be transmitted (as it may be in other imaging operations) to define the polarity of the event (ON or OFF-event), similar to the base DVS systems. As a result, in some embodiments, the required number of address bits that need to be communicated off-chip may be reduced with respect to the base DVS system. Hence, the P²M architecture may maintain the energy benefit of a sparse system due to utilizing the AER read scheme along with lower off-chip communication energy cost due to generating the fewer number of address bits per output activation. In some embodiments, modifications to the standard AER scheme may be made so that it may be compatible with asynchronous processing in-pixel computations.

### Process Integration and Area Consideration

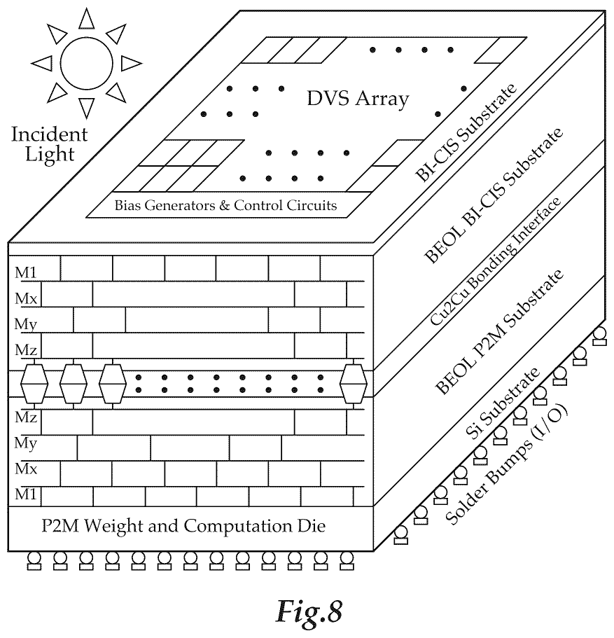

FIG. 8 exhibits the representative illustration of a heterogeneously integrated system featuring our proposed Neuromorphic P²M paradigm. FIG. 8 depicts a representative schematic showing a heterogeneously integrated system featuring Neuromorphic P²M paradigm utilizing Cu2Cu bonding. In some embodiments, the proposed system may be divided into two dies, i) a backside illuminated CMOS image sensor (BI-CIS), consisting of DVS pixels and biasing circuitry, and ii) a die containing multi-bit multi-channel weight transistors, accumulation capacitors, comparators, AER read circuits, etc. From FIGS. 5A-5B, it may be observed that for each spatial feature (DVS pixels), the algorithm may require multiple numbers of channels that may incur higher area (e.g., fabrication area) due to the multiple weight transistors and one accumulation capacitor (or other accumulation circuitry) per channel. However, due to the advantages of heterogeneous integration, in some embodiments, the bottom die (as depicted in FIG. 8) may be fabricated on an advanced technology node compared to the top die (BI-CIS). Hence, multiple channels in the bottom die may be accommodated and aligned with the top die without any area overhead while maintaining the neural network model accuracy. It may be noted that typical DVS pixels, in some embodiments, may be larger (e.g., than weighting circuitry) due to the presence of a capacitive feedback difference amplifier. In some embodiments, the overall system may be fabricated by a wafer-to-wafer bonding process using pixel-level hybrid Cu2Cu (copper to copper) interconnects. In some embodiments, each DVS pixel may have two Cu2Cu interconnects for its ON and OFF-channel, respectively. Considering a representative DVS pixel area of 40 μm×40 μm for a 128×128 sensor array, a Cu2Cu hybrid bonding pitch of 1 μm and the analog convolution elements (weight transistors, comparators, accumulation capacitors) area in the GF22FDX node, the Neuromorphic P²M architecture may, in some embodiments, support a maximum of 128 and 32 channels with a kernel size of 3×3 for stride 2 and 1, respectively. In some embodiments, almost 47% of the area of the bottom die (e.g., analog MAC elements containing die) may be occupied by accumulation capacitor(s) of multiple channels throughout the array. In some embodiments, such kernel-parallel MAC structure may allow enablement of an in-situ convolution operation without a need for weight transfer (e.g., for a weight value to be read) from a different physical location, thus this method may not lead to any data bandwidth or energy bottleneck.

### P²M-Constrained Algorithm-Hardware Co-Design

In some embodiments, an algorithmic framework implementation may be guided by the proposed Neuromorphic P²M architecture. The in-pixel charge-based analog convolution may generate non-ideal non-linear convolution while process variation may yield deviation of the convolution result from the ideal output. Moreover, leakage (e.g., accumulation capacitor leakage, transistor gate leakage, etc.) may pose constraints on the maximum length of each algorithmic time step, while area constraints may limit the number of channels which may be utilized per each spatial feature map. More details on including non-idealities, process variation, leakage, and area effects in the algorithmic framework are given in the following subsections.

### Custom Convolution for the First Layer Modeling Circuit Non-Linearity and Process Variation

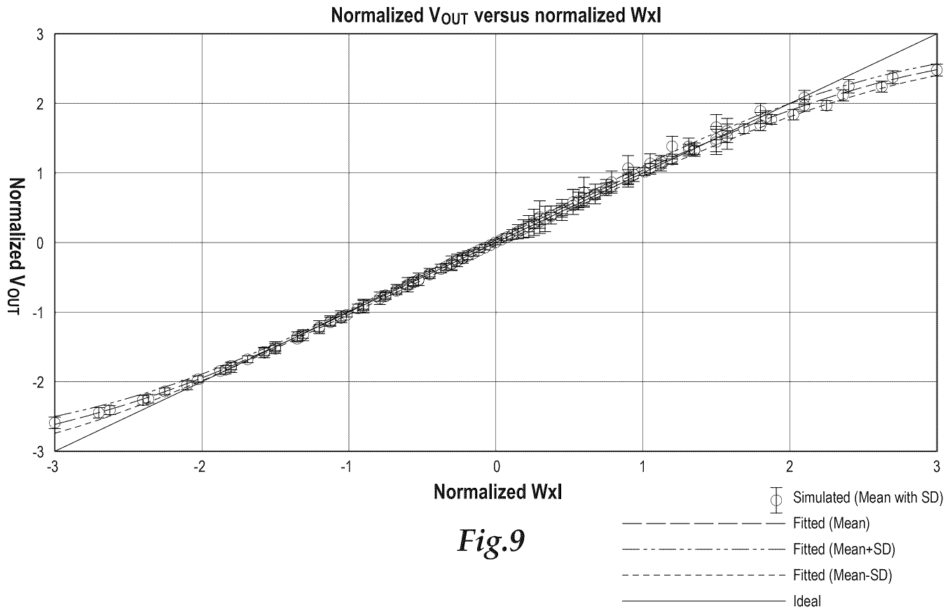

From an algorithmic perspective, the first layer of a CNN may be regarded as a linear convolution layer followed by a non-linear activation unit. In some embodiments, in the Neuromorphic P²M paradigm, the weights of the first layer of the CNN may be implemented by utilizing voltage accumulation through appropriately sized transistors, where such transistors may be inherently non-linear. As a result, analog convolution circuits built on transistor devices may exhibit non-ideal, non-linear behavior. In some embodiments, to suppress the non-linearity, the weights (e.g., transistor's geometry) may be tuned in a non-linear manner in such a way that the output accumulation voltage steps may increase or decrease linearly for positive and negative weights, respectively. However, the nonlinearity may also be a function of the drain-source voltage of the weight transistors. In some embodiments, the kernel's capacitor voltage may be charged or discharged during the computation phase. The charging and discharging current may depend on the weight values, and may be functionally dependent on V_{DS}. Therefore, when the accumulation voltage (V_{OUT} node in FIGS. 2A-3F) gets larger (smaller) for the positive (negative) weights, the transistor may enter into the triode region, where the charging or discharging current may be reduced. Furthermore, the exact same positive and negative weight values may not ensure the exact same change in voltage accumulation due to device asymmetry (e.g., pMOS for positive weight implementation and nMOS for negative weight implementation). Additionally, due to process variation, the transistor's geometry may not be fabricated precisely, and the convolution output current may also vary due to process variation. In some embodiments, by taking into consideration all these non-linear non-ideal behaviors and process variations, the proposed P²M paradigm may be successfully simulated for a wide range of input spikes and weights combinations considering leakage and around 3-sigma variation using GF22 nm FD-SOI technology node. FIG. 9 illustrates the resulting HSpice results with a standard deviation bar, e.g., the normalized convolution output voltages per pixel corresponding to a range of weights and input number of spikes, which have been modeled using a behavioral curve-fitting function. FIG. 9 depicts a graph showing a scatter plot with standard deviation comparing the pixel output voltage to ideal multiplication value of Weights×Input activation (Normalized W×I). In the algorithmic framework, a random Gaussian sample value has been generated between the mean+standard deviation for each particular normalized weight times input event value to capture the effects of the process variation for the simulation. For the fixed simulation time for the event stream, in each kernel, the accumulation output voltage per pixel may be calculated first, then added to the other pixel's accumulation voltage inside the kernel to calculate the final output. The algorithmic framework was then used to optimize the CNN training for the event-driven neuromorphic datasets.

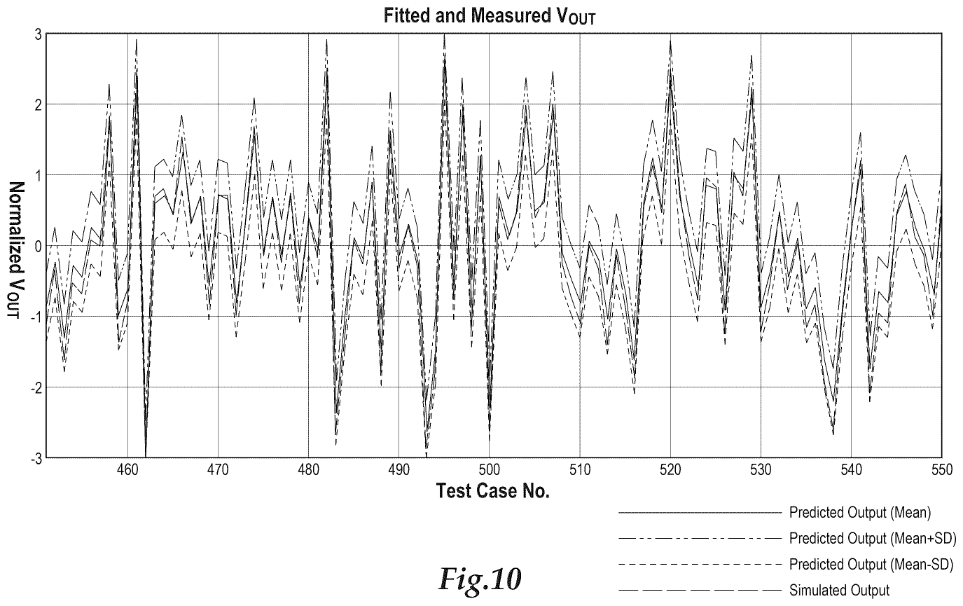

In some embodiments, in order to validate the Hspice simulations generated curve-fitting function's prediction accuracy, 1000 random cases have been tested. In these test cases, a kernel size of 3×3 has been used, where the weight values have been generated randomly. Moreover, the number of input event spikes and time instants for the input spikes were also randomly generated. Among 1000 random tests, only 100 test results (for clear visibility) are shown in FIG. 10. FIG. 10 depicts a graph showing a plot of 100 random HSpice simulation results for 3×3 kernel benchmarking with the fitted equations. In the figure, curve-fitted mean, and mean±standard deviation predictions of the proposed analog MAC operations are depicted along with HSpice-generated simulation results. A 3rd order single variable (normalized weight times input event spikes) polynomial has been used to generate the curve fitting functions (mean, mean±standard deviation) considering 0.55% mean root mean square error (RMSE) of the analog MAC to minimize the computation complexity in the algorithmic framework while maintaining accuracy. In FIG. 10, it may be clearly seen that the predicted mean output follows the Hspice results closely, and the HSpice outputs fall between the mean±standard deviation value.

### Circuit-Algorithm Co-Optimization of SNN Backbone Subject to P²M Constraints

In some embodiments, in the proposed Neuromorphic P²M architecture, a kernel-dedicated capacitor has been utilized to enable substantially instantaneous and massively parallel spatio-temporal convolution operation across different channels. In some embodiments, a kernel-dedicated capacitor may be needed to preserve the temporal information of input DVS spikes across different channels simultaneously. However, in some embodiments as discussed previously, almost 47% of the area in our P²M array may occupied by the capacitors only. Further, there may be a direct trade-off between the acceptable leakage and capacitance value (e.g., a large capacitor may incur a large area, however, may also result in lower leakage). Therefore, in some embodiments, the number of channels in the SNN models may be reduced as compared to the baseline neural architecture in order to avoid incurring any area overhead while preserving the model accuracy. In addition, the leakage may also limit the length of each algorithmic time step in our algorithmic framework. In some embodiments, therefore, the time length in the neural network model may be reduced, such as in order to minimize the kernel-dependent leakage error of the custom first convolution layer. Moreover, to reduce the amount of data transfer between the P²M architecture and the backend hardware processing of the remaining SNN layers, a max pooling layer may be avoided and instead a stride of 2 may be used in the P²M convolutional layer. Lastly, in some embodiments, Monte Carlo variations may be incorporated into the proposed non-linear custom convolutional layer explained above in the algorithmic framework. In particular, the mean and standard deviation of the output of the custom convolutional layer may be estimated from extensive circuit simulations. In some embodiments, the SNN may then be trained with the addition of the standard deviation as noise to the mean output of the convolutional layer. In some embodiments, the noise addition during training may be crucial to increase the robustness of the SNN models, as otherwise, our models may lead to a drastic test accuracy drop with neuromorphic P²M.

### Benchmarking Dataset and Model

In some embodiments, the P²M paradigm may be focused on performing event-driven neuromorphic tasks, such as where the goal may be to classify each video sample captured by the DVS cameras. In some embodiments, the P²M approach may be evaluated on two different large-scale popular neuromorphic benchmarking datasets.
DVS128-Gesture: The IBM DVS128-Gesture is a neuromorphic gesture recognition dataset with a temporal resolution in us range and a spatial resolution of 128×128. It consists of 11 gestures (1000 samples each), such as hand clap, arm roll, etc., recorded from 29 individuals under three illumination conditions, and each gesture has an average duration of 6 seconds. In some embodiments, it may be regarded as the most challenging open-source neuromorphic dataset with the most precise temporal information.
NMNIST: The neuromorphic MNIST dataset is a converted dataset from MNIST. It consists of 50K training images and 10K validation images. In some embodiments, NMNIST may be preprocessed in the same way as in N-Caltech 101. In some embodiments, images may be resized to 34×34 (e.g., pixels).

For all these datasets, in some embodiments a 9:1 train-valid split is applied. In some embodiments, the spikingjelly package may be used to process the data and integrate them into a fixed time interval of 1 ms based on the kernel's capacitor retention time supported by the neuromorphic P²M circuit. However, in some embodiments, such a small integration time may lead to a large number of time steps for the neuromorphic datasets considered in this work whose input samples are at least a few seconds long. This may significantly exacerbate the training complexity. To mitigate this concern, in some embodiments, an SNN model may first be pretrained with a large integration time in the order of seconds (e.g., with a small number of time steps) without any P²M circuit constraints. The integration time of the first spiking convolutional layer for P²M implementation may then be decreased and the spikes may be integrated in the second interval such that the network from the second layer processes the input with only a few time steps. This network from the second layer may then be fine tuned while freezing the first layer—e.g., due to memory constraints. In some embodiments, four convolutional layers may be used, followed by two linear layers at the end with 512 and 10 neurons respectively. In some embodiments, each convolutional layer may be followed by a batch normalization layer, spiking LIF layer, max pooling layer, etc.

TABLE 1
Comparison of the test accuracy of the P²M enabled SNN models
with the baseline SNN counterparts, where ‘MP’ denotes
membrane potential, ‘Custom Conv.’ denotes the incorporation
of the non-ideal model to the ML algorithmic framework,
and ‘Reduced dimensionality’ denotes the reduction
in the number of channels in the first convolutional layer.

| | MP 1^{st} | Custom | Reduced | Accuracy |
|---|---|---|---|---|
| Dataset | layer | Conv. | dimensionality | (%) |
| DVS128-Gesture | ✓ | x | x | 93.40 |
| DVS128-Gesture | x | x | x | 88.78 |
| DVS128-Gesture | x | ✓ | x | 88.54 |
| DVS128-Gesture | x | ✓ | ✓ | 88.36 |
| NMNIST | ✓ | x | x | 98.10 |
| NMNIST | x | x | x | 93.68 |
| NMNIST | x | ✓ | x | 93.44 |
| NMNIST | x | ✓ | ✓ | 93.12 |

### Classification Accuracy

For some embodiments, the performance of the baseline and P²M custom SNN models where evaluated on the two datasets illustrated above in Table 1. Note that all these models have been trained from scratch. In some embodiments, as can be seen from Table 1, the custom convolution model may not incur any significant drop in accuracy for any of the two datasets. However, the removal of the state variable, e.g., the membrane potential in the first layer may lead to ˜18 5% drop in test accuracy on average. This may be because of the loss in the temporal information of the input spike integration from the DVS camera. Additional P²M constraints—such as a fewer number of channels and increased strides in the first convolutional layer (as described previously)—may hardly incur any additional drop in accuracy. Overall, in the tested embodiments, the P²M-constrained models may lead to a 5.2% drop in test accuracy on average across the two datasets.

### Analysis of Energy Consumption

In some embodiments, a circuit-algorithm co-simulation framework may be developed to characterize the energy consumption of baseline and P²M—implemented SNN models for neuromorphic datasets. Note, the latency of the models is not evaluated since that may depend heavily on the underlying hardware architecture and data flow of the backend hardware. The total energy consumption for both these models may be partitioned into three major components: sensor (Eₛₑₙₛ), sensor-to-SoC communication (E_{com}), and SoC energy (Eₛₙₙ) to process the SNN layers (except the first layer for the P²M implementation). Eₛₙₙ may be primarily composed of the accumulation operations incurred by the spiking convolutional layers (E_{ac}) and parameter read (E_{read}) cost. Assuming T denotes the total number of time steps and s denotes the sparsity, the total energy may be approximated as shown in Equation 1, below:

$$\begin{matrix} & & \\ {E}_{tot} \approx {e}_{event} * {N}_{event} & + {e}_{a c} * {N}_{a c} * s * T & + {e}_{read} * {N}_{read} \\ {E}_{sens} & {E}_{sens} & {E}_{sens}\end{matrix} \qquad ( 1 )$$

Here, eₑᵥₑₙₜ may represent per-pixel sensing energy, and Nₑᵥₑₙₜ may denote the number of events communicated from the sensor to the backend. Note that the first convolutional layer of the SNN in the baseline implementation may require MAC operations, and hence, e_{ac} may be replaced with the MAC energy e_{mac} and use s=1. For a spiking convolutional layer that takes an input I∈R^{h}i×wi×ci and weight tensor θ∈R^{k×k×c}i×co to produce output O∈R^{h}o×wo×co, the N_{ac} and N_{read} may be computed as shown in Equations 2 and 3, below,

$${N}_{a c} = {h}_{o} * {w}_{o} * {k}^{2} * {c}_{i} * {c}_{o} \qquad ( 2 )$$

$${N}_{r e a d} = {k}^{2} * {c}_{i} * {c}_{o} \qquad ( 3 )$$

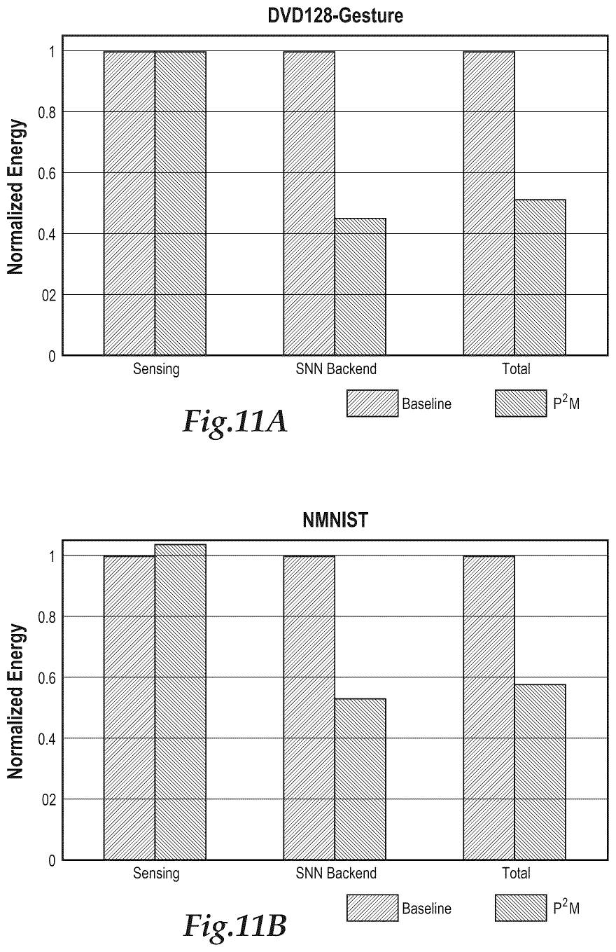

The energy values used to evaluate Eₜₒₜ are presented in Table 2. While eₑᵥₑₙₜ is obtained from circuit simulations, e_{ac} and e_{read} are obtained from other references. FIGS. 11A-11B shows the comparison of energy costs for standard vs P²M-implemented SNN models for the DVS datasets. FIGS. 11A-11B depict graphs showing plots of comparison of the energy consumption between baseline and P²M implementations of SNNs to process neuromorphic images from (a) DVS128-Gesture, and (b) NMNIST datasets. In particular, as shown, P²M may yield an energy reduction of up to 1.95×. This reduction may primarily come from the reduced energy consumption in the backend since the compute of the first convolutional layer of the SNN may be offloaded. This layer may consume more than 50% of the total energy since it may involve energy intensive MAC operations (e.g., due to event accumulation before convolution computation) which may consume up to ˜32× more energy compared to cheap accumulate operations with 32-bit fixed point representation.

TABLE 2
Energy estimation for different hardware components. The energy values
are measured for designs in 22 nm CMOS technology. Note, the sensing
energy includes the analog convolution energy for P²M as analog
convolution is performed as a part of the sensing operation. The
communication energy has been estimated considering 5 pF of output
loading at the receiver side at 1 MHz speed. For e_{mac} and e_{ac}, we
convert the corresponding value in 45 nm to that of 22 nm by following
standard scaling strategy

| | Sensing | Comm | MAC | MAdds |
|---|---|---|---|---|
| | Energy (pJ) | Energy (pJ/bit) | Energy (pJ) | Energy (pJ) |
| Model type | (eₑᵥₑₙₜ) | (e_{comm}) | (e_{mac}) | (e_{ac}) |
| P²M (ours) | 46.96 | 1.6 | 1.568 | 0.03 |
| Baseline | 46.06 | 1.6 | 1.568 | 0.03 |

In some embodiments, a in-pixel-in-memory processing paradigm is proposed and implemented for neuromorphic event-based sensors. Instead of generating event spikes based on the change in contrast of scenes, the proposed solutions may directly send the low-level output features of the convolutional neural network. By leveraging advanced 3D integration technology, in-situ massively parallel charge-based analog spatio-temporal convolution may be performed across a pixel array. Moreover, hardware (e.g., non-linearity, process variation, leakage) constraints of our analog computing elements as well as area consideration (e.g., limiting the maximum number of channels of the first neural network layer) may be incorporated into the algorithmic framework. Our P²M-enabled SNN models may yield an accuracy of 88.36% on the IBM DVS128-Gesture dataset and achieved 1.95× energy reduction compared to the conventional system.

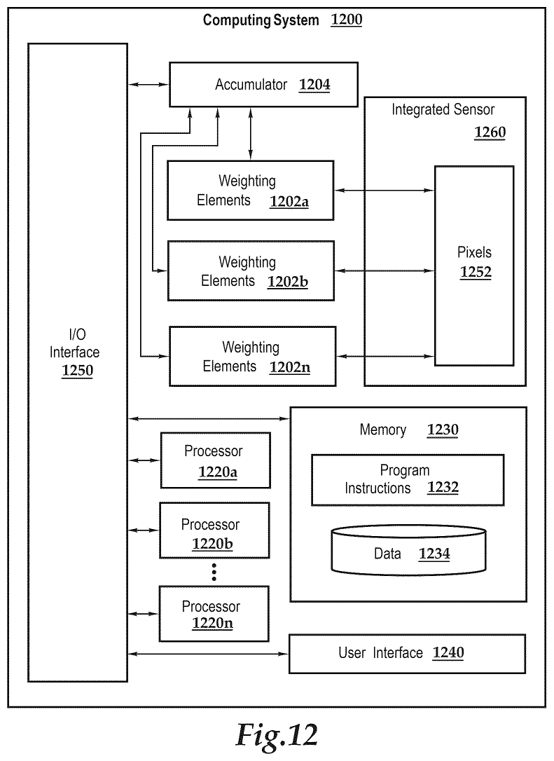

FIG. 12 is a system diagram that illustrates an example computing system comprising processing in pixel, in accordance with one or more embodiments. Various portions of systems and methods described herein may include or be executed on one or more computing systems similar to computing system 1200. Further, processes and modules described herein may be executed by one or more processing systems similar to that of computing system 1500.

Computing system 1200 may include one or more processors (e.g., processors 1220a-1220n) coupled to system memory 1230, and a user interface 1240 via an input/output (I/O) interface 1250. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1200. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1230). Computing system 1200 may be a uni-processor system including one processor (e.g., processor 1220a-1220n), or a multi-processor system including any number of suitable processors (e.g., 1220a-1220n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1200 may include a plurality of computing devices (e.g., distributed computing systems) to implement various processing functions.

Computing system 1200 may include one or more accumulator 1204 (e.g., accumulator capacitor), coupled to system memory 1230, and a user interface 1240 via an input/output (I/O) interface 1250. The accumulator 1204 may also be coupled to weighting elements 1202a-1202n, respectively, and to pixels 1252. The accumulator 1204 may operate on outputs of the weighting elements 1202a-1202n, which may allow transmission (e.g., pass-through) of the outputs of the pixels 1252. The pixels 1252 may correspond to multiple photosensors. The pixels 1252 may instead correspond to multiple sensors. The weighting elements 1202a-1202n may be controlled by one or more kernels. The kernels may determine values of the weighting elements 1202a-1202n. The output corresponding to each of the kernels may be determined based on the value(s) of the accumulator 1204. The weighting elements 1202a-1202n may be transistors or any other appropriate elements as previously described. The accumulator 1204 may instead be any appropriate accumulation elements, as previously described. The pixels 1252 may be connected to one or more of the weighting elements 1202a-1202n. The weighting elements 1202a-1202n may be connected to one or more accumulator 1204, as previously described. The pixels 1252 may be controlled by one or more reset element, such as a reset element (not depicted) in communication with the I/O interface 1250 or controlled by one or more of the processors 1220a-1220n. The pixels 1252 may be exposed to input, such as light (e.g., in the case of a photosensor) or other input, an analyte (such as temperature), or other sensing material. The pixels 1252 may comprise transistors, diodes, etc.

The user interface 1240 may comprise one or more I/O device interface, for example to provide an interface for connection of one or more I/O devices to computing system 1200. The user interface 1240 may include devices that receive input (e.g., from a user) or output information (e.g., to a user). The user interface 1240 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. The user interface 1240 may be connected to computing system 1200 through a wired or wireless connection. The user interface 1240 may be connected to computing system 1200 from a remote location. The user interface 1240 may be in communication with one or more other computing systems. Other computing units, such as located on remote computer system, for example, may be connected to computing system 800 via a network.

System memory 1230 may be configured to store program instructions 1232 or data 1234. Program instructions 1232 may be executable by a processor (e.g., one or more of processors 1220a-1220n) to implement one or more embodiments of the present techniques. Program instructions 1232 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1230 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 1230 may include a non-transitory computer readable storage medium that may have program instructions stored thereon that are executable by a computer processor (e.g., one or more of processors 1220a-1220n) to cause the subject matter and the functional operations described herein. A memory (e.g., system memory 1230) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1250 may be configured to coordinate I/O traffic between processors 1220a-1220n, accumulator 1204, system memory 1230, user interface 1240, etc. I/O interface 1250 may perform protocol, timing, or other data transformations to convert data signals from one component (e.g., system memory 1230) into a format suitable for use by another component (e.g., processors 1220a-1220n). I/O interface 1250 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 1200 or multiple computing systems 1200 configured to host different portions or instances of embodiments. Multiple computing systems 1200 may provide for parallel or sequential processing/execution of one or more portions of the techniques described herein.

Those skilled in the art will appreciate that computing system 1200 is merely illustrative and is not intended to limit the scope of the techniques described herein. Computing system 1200 may include any combination of devices or software that may perform or otherwise provide for the performance of the techniques described herein. For example, computing system 1200 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1200 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1200 may be transmitted to computing system 1200 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter lends itself to economies in the application process. But the distinct advantages and aspects of such disclosures should not be conflated. In some cases, embodiments address all of the deficiencies noted herein, but it should be understood that the disclosures are independently useful, and some embodiments address only a subset of such problems or offer other, unmentioned benefits that will be apparent to those of skill in the art reviewing the present disclosure. Due to costs constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (e.g., meaning having the potential to), rather than the mandatory sense (e.g., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, e.g., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, e.g., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In this patent filing, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques may be better understood with reference to the following enumerated embodiments:
1. An integrated circuit comprising: a sensor structure; a set of weighting elements, each configured to weight an output of the sensor structure; and an accumulation element, the accumulation element configured to collect weighted outputs of the set of weighting elements over an accumulation time.
2. The integrated circuit of embodiment 1, wherein the sensor structure comprises a sensor array.
3. The integrated circuit of embodiment 2, wherein the sensor array is an array of event detection sensors.
4. The integrated circuit of embodiment 2, wherein the sensor array is an array of dynamic vision sensors.
5. The integrated circuit of embodiment 2, wherein the sensor array is an array of sensors with asynchronous outputs.
6. The integrated circuit of embodiment 5, wherein the sensors with asynchronous outputs have outputs with magnitudes corresponding to a direction of detection.
7. The integrated circuit of embodiment 1, wherein the accumulation element is an accumulation capacitor.
8. The integrated circuit of embodiment 1, wherein the sensor structure further comprises a memory structure.
9. The integrated circuit of embodiment 8, wherein the accumulation element comprises the memory structure.
10. The integrated circuit of embodiment 8, wherein the memory structure is an analog memory structure.
11. The integrated circuit of embodiment 8, wherein the memory structure comprises a non-volatile memory structure.
12. The integrated circuit of embodiment 1, wherein the sensor structure further comprises a reset element.
13. The integrated circuit of embodiment 12, wherein the reset element is configured to reset a value of the accumulation element.
14. The integrated circuit of embodiment 1, wherein the set of weighting elements comprises a set of weighting transistors.
15. The integrated circuit of embodiment 14, wherein the set of weighting transistors comprises transistors of varying widths.
16. The integrated circuit of embodiment 14, wherein the set of weighting transistors comprises transistors of varying W/L.
17. The integrated circuit of embodiment 1, wherein each of the set of weighting elements is configured to be selected by one or more of a set of select lines.
18. The integrated circuit of embodiment 17, wherein selecting one of the set of weighting elements comprises turning the one of the set of weighting elements on.
19. The integrated circuit of embodiment 17, wherein each of the set of select lines corresponds to a kernel.
20. The integrated circuit of embodiment 1, wherein the set of weighting elements correspond to a weighting values for a layer of a machine learning model.
21. The integrated circuit of embodiment 20, wherein the machine learning model is a spiking neural network.
22. The integrated circuit of embodiment 1, further comprising a computational element configured to perform a computational process based on the weighted outputs of the set of weighting elements.
23. The integrated circuit of embodiment 1, further comprising homogeneous integration.
24. The integrated circuit of embodiment 1, further comprising heterogeneous integration.
25. The integrated circuit of embodiment 1, further comprising an address-event representation (AER) communication element.
26. An integrated circuit structure comprising: an array of cells, wherein each cell comprises at least a first integrated circuit of any one of embodiments 1 to 25.
27. The integrated circuit structure of embodiment 26, further comprising a convolution output element configured to collect weighted outputs of the set of weighting elements of one or more of the cells.
28. The integrated circuit structure of embodiment 26, wherein at least some of the cells share an accumulation element.
29. A method of fabricating the integrated circuit of any one of embodiments 1 to 25.
30. A method of fabricating the integrated circuit structure of any one of embodiments 26 to 28.

1. An integrated circuit comprising:
a sensor structure;
a set of weighting elements, each configured to weight an output of the sensor structure; and
an accumulation element, the accumulation element configured to collect weighted outputs of the set of weighting elements over an accumulation time.

2. The integrated circuit of claim 1, wherein the sensor structure comprises a sensor array.

3. The integrated circuit of claim 2, wherein the sensor array is an array of event detection sensors or dynamic vision sensors.

4. The integrated circuit of claim 2, wherein the sensor array is an array of sensors with asynchronous outputs.

5. The integrated circuit of claim 4, wherein the sensors with asynchronous outputs have outputs with magnitudes corresponding to a direction of detection.

6. The integrated circuit of claim 1, wherein the accumulation element is an accumulation capacitor.

7. The integrated circuit of claim 1, wherein the sensor structure further comprises a memory structure.

8. The integrated circuit of claim 7, wherein the accumulation element comprises the memory structure.

9. The integrated circuit of claim 8, wherein the memory structure is an analog memory structure.

10. The integrated circuit of claim 8, wherein the memory structure comprises a non-volatile memory structure.

11. The integrated circuit of claim 1, wherein the sensor structure further comprises a reset element.

12. The integrated circuit of claim 11, wherein the reset element is configured to reset a value of the accumulation element.

13. The integrated circuit of claim 1, wherein the set of weighting elements comprises a set of weighting transistors.

14. The integrated circuit of claim 13, wherein the set of weighting transistors comprises transistors of varying W/L.

15. The integrated circuit of claim 1, wherein each of the set of weighting elements is configured to be selected by one or more of a set of select lines.

16. The integrated circuit of claim 15, wherein selecting one of the set of weighting elements comprises turning the one of the set of weighting elements on.

17. The integrated circuit of claim 15, wherein each of the set of select lines corresponds to a kernel.

18. The integrated circuit of claim 1, wherein the set of weighting elements correspond to a weighting values for a layer of a machine learning model.

19. The integrated circuit of claim 18, wherein the machine learning model is a spiking neural network.

20. The integrated circuit of claim 1, further comprising a computational element configured to perform a computational process based on the weighted outputs of the set of weighting elements.

21. The integrated circuit of claim 1, further comprising an address-event representation (AER) communication element.

22. An integrated circuit, comprising:
an array of cells, wherein each cell comprises:
a sensor;
a set of weighting elements, each configured to weight an output of the sensor; and
an accumulator configured to collect weighted outputs of the set of weighting elements over an accumulation time.

23. The integrated circuit structure of claim 22, further comprising a convolution output element configured to collect weighted outputs of the set of weighting elements of one or more of the cells.

24. The integrated circuit structure of claim 23, wherein at least some of the cells share an accumulation element.
